(19) United States
(12) Patent Application Publication
(10) Pub. No.: US 2024/0160714 A1
(43) Pub. Date: May 16, 2024

(54) ACCESS CONTROL MANAGEMENT SYSTEM, ACCESS CONTROL MANAGEMENT METHOD AND IMAGE CAPTURE DEVICE

(71) Applicant: DeCloak Intelligences Co., Taipei City (TW)

(72) Inventors: Yao-Tung Tsou, Taipei City (TW); Yun-Yu Wang, Taipei City (TW); Guo-Cheng Chien, Taipei City (TW); Kuo-Yu Chang, Taipei City (TW)

(73) Assignee: DeCloak Intelligences Co., Taipei City (TW)

(21) Appl. No.: 18/462,410

(22) Filed: Sep. 7, 2023

Related U.S. Application Data
(60) Provisional application No. 63/425,274, filed on Nov. 14, 2022.
(60) Provisional application No. 63/434,911, filed on Dec. 22, 2022.

(30) Foreign Application Priority Data
Jul. 28, 2023 (TW) 112128407

(51) Int. Cl. G06F 21/32; G06V 40/16; G06V 40/40; G07C 9/37

(52) U.S. Cl. CPC G06F 21/32; G06V 40/168; G06V 40/172; G06V 40/45; G07C 9/37

(57) ABSTRACT

An access control management system, access control management method and an image capture device are provided. The access control management system includes an image capture device and a processing device. The image capture device includes: a lens; an image sensor configured to sense a light intensity passing through the lens to generate an image of a subject being captured; an image signal processor (ISP) configured to capture a face image in the generated image, perform a de-identification processing on the face image to obtain de-identified image data, and transform the de-identified image data into multiple de-identified features; and an I/O interface configured to output the de-identified features. The processing device is configured to verify an identity of a user to which the de-identified features belong by a trained deep learning model. The deep learning model is trained by using de-identified features and identities of multiple users registered in advance.

### CROSS-REFERENCE TO RELATED APPLICATION

This application claims the priority benefit of U.S. provisional application Ser. No. 63/425,274, filed on Nov. 14, 2022, U.S. provisional application Ser. No. 63/434,911, filed on Dec. 22, 2022 and Taiwan application serial no. 112128407, filed on Jul. 28, 2023. The entirety of each of the above-mentioned patent applications are hereby incorporated by reference herein and made a part of this specification.

### BACKGROUND

### Technical Field

The disclosure relates to an identification system and an identification method, and in particular relates to an access control management system, an access control management method, and an image capture device.

### Description of Related Art

Facial recognition has become a cutting-edge solution in various industries due to its ability to secure access control, provide strong identity verification, promote goods and services, and speed up financial operations. However, these applications often come at the expense of user interests, such as privacy and even security. To make matters worse, the facial recognition feature of access control systems has raised concerns among businesses about potential leaks of their facial data repositories, thereby violating privacy laws and/or generating high maintenance costs.

Traditional solutions typically outsource all sensitive facial data to a central server, or execute a decentralized model for local use. However, outsourced solutions violate privacy regulations by exposing user data to third-party service providers or insecure execution environments. On the other hand, although local solutions may protect user privacy to a certain extent, they still suffer from device theft and privacy leakage, and are limited by scalability, flexibility, and power consumption.

### SUMMARY

An access control management system, an access control management method, and an image capture device are provided in the disclosure, in which secure identity verification may be performed in a manner that does not reveal privacy.

An access control management system, which is configured to control the opening of a gate or the entry and exit of an entrance, is provided in the disclosure. The access control management system includes an image capture device and a processing device. The image capture device, disposed at the gate or the entrance, captures a face image of a user to be identified, de-identifies the face image to obtain de-identified image data, and converts the de-identified image data into multiple de-identified features, which are then output. The processing device verifies an identity of the user to which the de-identified features belong by a trained first deep learning model, and controls the opening of the gate or the entry and exit of the entrance according to a verification result. The first deep learning model is trained by using de-identified features and identities of multiple users registered in advance.

In some embodiments, the image capture device includes a lens, an image sensor, an image signal processor, and an input/output (I/O) interface. The image sensor is configured to sense light intensity passing through the lens to generate an image of the gate or the entrance. The image signal processor is configured to capture a face image in the image, de-identify the face image to obtain de-identified image data, and convert the de-identified image data into multiple de-identified features. The I/O interface is configured to output multiple de-identified features.

In some embodiments, the image signal processor includes a display for displaying the de-identified image data generated by the image signal processor.

In some embodiments, the processing device further includes: a first communication device, configured to communicate with the image capture device or connect to a network; and the image capture device further includes: a second communication device configured to communicate with the first communication device or connect to the network.

In some embodiments, the access control management system includes an interface device configured to connect the image capture device and the processing device.

In some embodiments, the first deep learning model is implemented by an application programming interface (API) attached to a processor of the processing device.

In some embodiments, the image signal processor includes de-identifying the face image by a second deep learning model supporting privacy protection technology.

In some embodiments, the second deep learning model includes multiple neurons divided into multiple layers, and the image signal processor converts the face image into feature values of multiple neurons in a first layer among the layers, inputs the converted feature values of each of the neurons to the next layer after adding noise generated by using a privacy parameter, and obtains the de-identified image data after processing multiple layers.

In some embodiments, the first deep learning model includes calculating a similarity between the de-identified features and a feature space established using the de-identified features of each user registered in advance, to verify the identity of the user to which the de-identified features belong according to the calculated similarity.

In some embodiments, the image capture device is further configured to identify a living body in the face image by a living body recognition technology, and de-identify the face image when the living body is identified in the face image. The living body recognition technology includes blink detection, deep learning features, challenge-response technology, or a three-dimensional camera.

An access control management method, which is configured to control the opening of a gate or the entry and exit of an entrance, is provided in the disclosure. The method includes the following operation. An image capture device including a lens, an image sensor, an image signal processor, and an input/output (I/O) interface are disposed at a gate or an entrance. Light intensity passing through the lens is sensed by the image sensor to generate an image of the gate or the entrance. A face image in the image is captured, the face image is identified to obtain de-identified image data, and the de-identified image data is converted into multiple de-identified features by the image signal processor. Multiple de-identified features are output by the I/O interface. The identity of the user to which the de-identified features belong is verified by the trained deep learning model by the processing device, and the opening of the gate or the entry and exit of the entrance are controlled according to the verification result. The first deep learning model is trained by using de-identified features and identities of multiple users registered in advance.

In some embodiments, the step of de-identifying the face image to obtain de-identified image data includes de-identifying the face image by a second deep learning model supporting privacy protection technology by the image capture device.

In some embodiments, the second deep learning model includes multiple neurons divided into multiple layers, the step of de-identifying the face image to obtain the de-identified image data includes converting the face image into feature values of multiple neurons in a first layer among the layers, inputting the converted feature values of each of the neurons to the next layer after adding noise generated by using a privacy parameter, and obtaining the de-identified image data after processing multiple layers.

In some embodiments, the step of verifying the identity of the user to which the de-identified features belong by the trained first deep learning model includes calculating a similarity between the de-identified features and a feature space established using the de-identified features of each user registered in advance, and verifying the identity of the user to which the de-identified features belong according to the calculated similarity.

In some embodiments, the method further includes identifing a living body in the face image by a living body recognition technology by the image capture device, and de-identifying the face image when the living body is identified in the face image.

In some embodiments, the method further includes displaying the de-identified image data generated by the image signal processor by a display of the image capture device.

An image capture device including a lens, an image sensor, an image signal processor, and an input/output (I/O) interface, is disclosed in the disclosure. The image sensor is configured 10 to sense light intensity passing through the lens to generate an image of the gate or the entrance.

The image signal processor is configured to capture a face image in the image, perform de-identification processing on the face image to obtain de-identified image data, and convert the de-identified image data into multiple de-identified features. The I/O interface is configured to output multiple de-identified features.

In some embodiments, the image signal processor includes de-identifying the face image by a deep learning model supporting privacy protection technology.

In some embodiments, the image signal processor does not store the face image in the image.

In some embodiments, the deep learning model includes multiple neurons divided into multiple layers, and the image signal processor converts the face image into feature values of multiple neurons in a first layer among the layers, adds the converted feature values of each of the neurons to the next layer after adding noise generated by using a privacy parameter, and obtains the de-identified image data after processing multiple layers.

Based on the above, the access control management system, the access control management method and the image capture device of the disclosure de-identify the face image without storing or uploading the actual photo of the user, so that the identity of the person entering the gate or entrance may be verified while avoiding the leakage of personal facial images.

In order to make the above-mentioned features and advantages of the disclosure comprehensible, embodiments accompanied with drawings are described in detail below.

### BRIEF DESCRIPTION OF THE DRAWINGS

FIG. 1 is a schematic diagram of a facial recognition system according to an embodiment of the disclosure.

FIG. 2 is a schematic diagram of a facial recognition method according to an embodiment of the disclosure.

FIG. 3 is a schematic diagram of a facial recognition method according to an embodiment of the disclosure.

FIG. 4 is a schematic diagram of an access control management system according to an embodiment of the disclosure.

FIG. 5 is a schematic diagram of the structure of an image capture device according to an embodiment of the disclosure.

FIG. 6A to FIG. 6C are schematic diagrams of images displayed by the access control management system according to an embodiment of the disclosure.

FIG. 7 is a schematic diagram of an access control management method according to an embodiment of the disclosure.

FIG. 8 is a flowchart of an access control management method according to an embodiment of the disclosure.

FIG. 9 is a block diagram of a facial recognition system according to an embodiment of the disclosure.

### DETAILED DESCRIPTION OF DISCLOSED EMBODIMENTS

In industries such as finance, healthcare, cryptocurrencies, and e-signature platforms, ensuring privacy when collecting data is critical. The facial recognition system of the embodiment of the disclosure is specially designed and built for cloud and edge computing, and an artificial intelligence (AI) recognition model is stored therein to achieve high computing efficiency. The embodiment of the disclosure also provides private and safe identification verification, where image processing is only completed on a local device, and sensitive personal facial photos are not uploaded to the cloud to avoid data leakage.

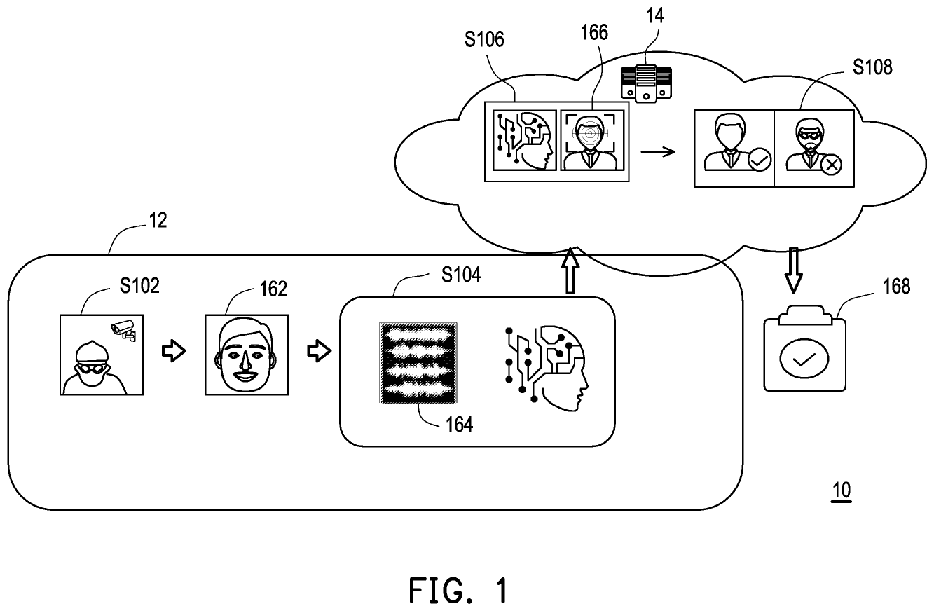

FIG. 1 is a schematic diagram of a facial recognition system according to an embodiment of the disclosure. Referring to FIG. 1, the facial recognition system 10 of this embodiment includes an image capture device 12 and a processing device 14.

The image capture device 12 is, for example, a local device or apparatus, which includes a charge coupled device (CCD), a complementary metal-oxide semiconductor (CMOS), or other types of photosensitive elements, that may sense light intensity to generate images of shooting scene. The image capture device 12 also includes a communication device supporting communication protocols such as wireless fidelity (Wi-Fi), radio frequency identification (RFID), Bluetooth, infrared, near-field communication (NFC), or device-to-device (D2D), or a network connection device supporting Internet connection, for communicating with external devices or connecting with a network. In some embodiments, the image capture device 12 further includes an image signal processor (ISP), which may be used to process the captured images.

The processing device 14 is, for example, a remote server, workstation or other electronic devices, and the processing device 14 includes a communication device, a storage device, and a processor. The communication device, for example, supports communication protocols such as wireless fidelity, radio frequency identification, Bluetooth, infrared, near field communication or device-to-device, or supports Internet connection, for communicating with the image capture device 12 or connecting with a network. The storage device is, for example, any type of fixed or removable random access memory (RAM), read-only memory (ROM), flash memory, a hard drive or a similar element or a combination of the above-mentioned elements for storing a computer program executable by a processor. The processor 13 is, for example, a central processing unit (CPU), or other programmable general-purpose or special-purpose microprocessor, a micro controller, a digital signal processor (DSP), a programmable controller, an application specific integrated circuit (ASIC), a programmable logic device (PLD), or other similar devices, or a combination of these devices, the disclosure is not limited thereto. In this embodiment, the processor may load a computer program from the storage device to execute the facial recognition method of the embodiment of the disclosure. In some embodiments, the processor of the processing device 14 is equipped with an application programming interface (API), which is embedded with a trained deep learning model that may be configured to verify the identity of the user.

In step S102, the image capture device 12 captures an image of the shooting scene, and performs facial recognition to obtain a face image 162. The image capture device 12, for example, executes a facial recognition algorithm on the captured image to capture the face image 162.

In step S104, the image capture device 12 de-identifies the face image 162 to obtain de-identified image data 164 by a deep learning model supporting privacy protection technology, converts the de-identified image data 164 into multiple de-identified features, and outputs them to the processing device 14. The aforementioned privacy protection technology includes differential privacy, homomorphic encryption, shuffling, or pixelating, but not limited thereto.

In step S106, the processing device 16 trains a deep learning model by using the de-identified features 166 and identities of multiple users registered in advance. The aforementioned deep learning model is, for example, a convolutional neural network (CNN), a deep neural network (DNN), a recurrent neural network (RNN), or other models with learning functions, the disclosure is not limited thereto.

In step S108, the processing device 16 verifies the identity of the user to which the de-identified features belong by the trained deep learning model, and outputs a verification result 168.

In some embodiments, the verification result 168 is used to identify the access authority of the file system, so as to verify the identity of the user entering the file system. In other embodiments, the verification result 168 may also be used in the authority verification process of the financial system and integrated with the original OTP verification process in the financial system to verify the identity of users entering the financial system. In the following example, the usage of the verification result 168 in the access control management system is taken as an example to verify the identity of people entering the gate or entrance.

In some embodiments, the facial recognition system 10, for example, adopts a loosely coupled deep neural network (DNN) as a deep learning model. By keeping a small portion of the neural layers on the local device/apparatus, and keeping the rest on the cloud or a third party server, an optimal balance may be achieved among computational resources, privacy loss, and model quality.

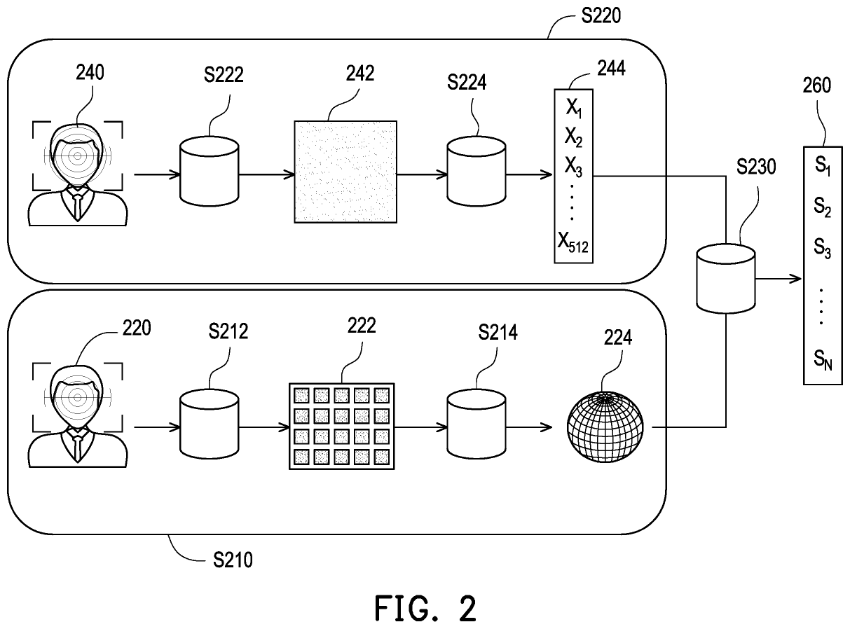

Based on the framework of the above-mentioned facial recognition system, the facial recognition system of this embodiment is divided into a registration stage and a recognition stage. FIG. 2 is a schematic diagram of a facial recognition method according to an embodiment of the disclosure. Referring to FIG. 1 and FIG. 2 at the same time, the facial recognition method of this embodiment is applied to the facial recognition system 10 in FIG. 1.

Step S210 is the registration stage, which includes step S212, where the image capture device 12 inputs the captured multiple face images 220 into a deep learning model (a second deep learning model) to generate multiple de-identified image data 222. The above-mentioned deep learning model includes multiple neurons that are divided into multiple layers, in which the deep learning model converts the face image into the feature values of multiple neurons in the first layer among the layers, inputs the converted feature values of each of the neurons to the next layer after adding noise generated by using a privacy parameter, and obtains the de-identified image data after processing multiple layers.

In detail, the deep learning model of this embodiment is a neural network model that performs privacy protection through the privacy protection algorithm of feature domain computation, that is, Nₓ_{ᵢ}+ [symbol] (0, ε²), where Nₓ_{ᵢ} is the specific data in the neural network, and [symbol] is the noise calculated using the noise distribution or permutation algorithm with the privacy parameter ε. It is worth noting that Nₓ_{ᵢ} is variable, which may be adjusted by the neural layer according to computing resources, privacy loss and model quality.

In step S214, the image capture device 12 further executes data processing on the de-identified image data, so as to convert the de-identified image data into multiple de-identified features, which are configured to establish a de-identified feature space 224. The feature space is obtained by, for example, an embedded space or a loss function, such as AdaFace or ArcFace, etc., which includes optimizing the margin of geodesic distance through the corresponding relationship of angles and radians in the normalized hypersphere.

On the other hand, step S220 is the recognition stage, which includes step S222, where the currently captured face image 240 is input into the trained deep learning model by the image capture device 12 to generate de-identified image data 242, and in step S224, the image capture device 12 performs data processing on the de-identified image data 242 to convert the de-identified image data 242 into multiple de-identified features, thereby outputting a de-identified feature vector 244. In this embodiment, the de-identified feature vector 244 includes 512 feature values X₁ to X₅₁₂, but it is not limited thereto.

Step S230 is also in the recognition phase, the processing device 14 verifies the identity of the user to which the de-identified features belong by the trained deep learning model (first deep learning model). The deep learning model is trained by using, for example, de-identified features and identities of multiple users registered in advance. In some embodiments, the processing device 14 calculates the similarity 260 between the de-identified features and the feature space established using the de-identified features of each user registered in advance, in which the similarity 260 includes the similarity S₁ to S_{N}, N is a positive integer, and the identity of the user to which the de-identified features belong is verified according to the magnitude of the similarity S₁ to S_{N}.

However, in other embodiments, the processing device 14 may adopt different activation functions such as S (sigmoid) function, hyperbolic tangent (tanh) function, etc., in the hidden layers of the deep learning model to calculate the output of neurons. It may use different conversion functions such as normalized exponential (softmax) function, etc., in the output layer to calculate the predicted results. Alternatively, it may use methods such as gradient descent (GD), backpropagation (BP), etc., to update the weights of each neuron in the hidden layers, the disclosure does not limit the method of verifying user identity with the deep learning model.

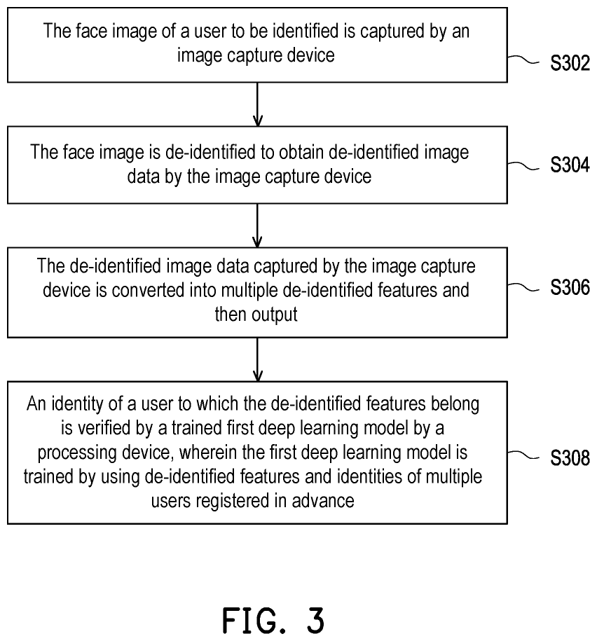

FIG. 3 is a schematic diagram of a facial recognition method according to an embodiment of the disclosure. Referring to FIG. 1 and FIG. 3 at the same time, the facial recognition method of this embodiment is adapted to the facial recognition system 10 in FIG. 1.

In step S302, the facial recognition system 10 captures a face image of the user to be identified by the image capture device 12.

In step S304, the image capture device 12 de-identifies the face image to obtain de-identified image data. The image capture device 12, for example, de-identifies the face image by a deep learning model supporting privacy protection technology. The privacy protection technology includes differential privacy, homomorphic encryption, shuffling or pixelating, but not limited thereto.

In step S306, the image capture device 12 converts the de-identified image data into multiple de-identified features and then outputs them.

In step S308, the processing device 14 verifies the identity of the user to which the de-identified features belong by the trained deep learning model. The deep learning model is trained by using, for example, de-identified features and identities of multiple users registered in advance. The processing device 14, for example, calculates the similarity between the de-identified features and a feature space established using the de-identified features of each user registered in advance by a deep learning model, to verify the identity of the user to which the de-identified features belong according to the calculated similarity.

In this embodiment, through the acceleration of edge and cloud computing, facial recognition may be performed efficiently. It not only eliminates the need for account passwords or other hardware keys, but also does not upload the face image of the user to the cloud in their original form. Therefore, identity verification may be performed securely without revealing personal information.

The design of the above-mentioned facial recognition system is flexible, may be easily integrated and interfaced with any existing system, and may also be customized according to specific requirements. Enterprises in different industries may quickly and easily integrate the facial recognition system of this embodiment into existing equipment or systems according to their own hardware equipment specifications and software requirements.

For example, the facial recognition system may be integrated into the access authority identification of the file system to verify the identity of the user entering the file system, or integrated into the authority verification process of the financial system and integrated with the original OTP verification process in the financial system to verify the identity of the user entering the financial system.

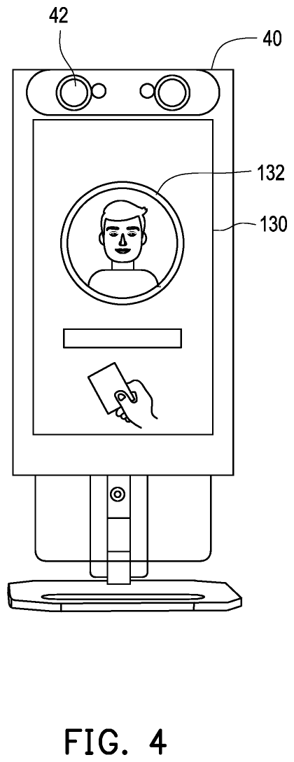

In the following embodiments, the integration of the facial recognition system into the access control management system is taken as an example to verify the identity of people entering the gate or entrance. FIG. 4 is a schematic diagram of an access control management system according to an embodiment of the disclosure. Referring to FIG. 4, the access control management system 40 of this embodiment may apply the facial recognition system 10 of FIG. 1 to verify the identity of the person who intends to enter the gate or entrance, and accordingly open the gate or allow the person to enter the entrance.

The access control management system 40 includes an image capture device 42, a display 130 and a transmission device (not shown). The image capture device 42 is configured to capture the face image of the user who intends to enter the gate or entrance. The display 130 is configured to display the face image 132 captured by the image capture device 42 or the image after de-identification, such as masking or face swapping. The transmission device is configured to transmit the de-identified features generated by the image capture device 42 to a remote processing device (not shown) to verify the identity of the user in the captured image and receive the verification result from the processing device, so as to decide whether to open the gate or allow the user to enter the entrance according to the verification result.

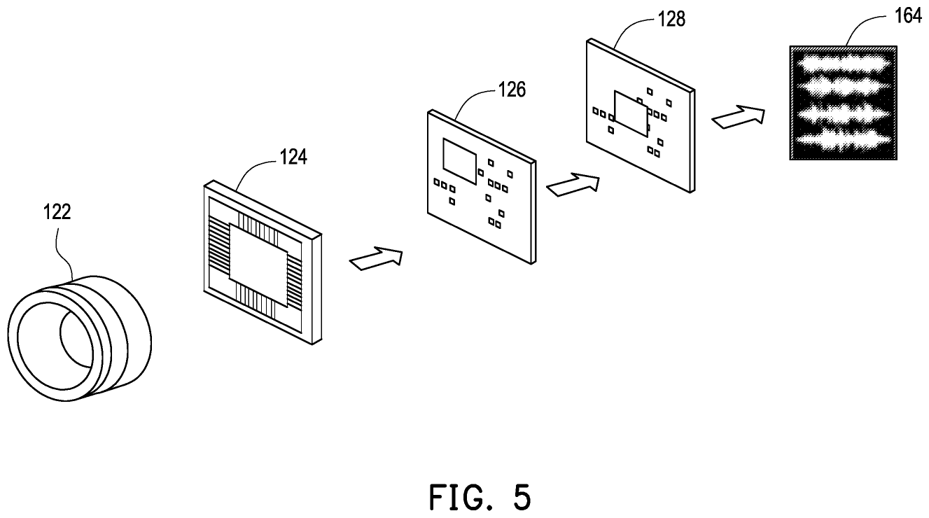

The image capture device 42 is, for example, provided with an image signal processor (ISP) supporting a neural network to de-identify the captured face image 132. For example, FIG. 5 is a schematic diagram of the structure of an image capture device according to an embodiment of the disclosure. Referring to FIG. 5, the image capture device 42 of this embodiment includes a lens 122, an image sensor 124, an image signal processor 126 and an input/output (I/O) interface 128.

The lens 122 includes multiple optical lenses, which are driven by actuators such as stepping motors or voice coil motors to change the relative positions of the lenses, thereby changing the focal length of the lens 122. The image sensor 124 is, for example, formed of a charge coupled device (CCD), a complementary metal-oxide semiconductor (CMOS) element, or other types of photosensitive elements, and is disposed behind the lens 122 to sense the light 25 intensity incident on the lens 122 to generate an image of the photographed object.

The image signal processor 126 is configured to process the image generated by the image sensor 124, including executing a facial recognition algorithm on the image to capture a face image. The image signal processor 126 further has a built-in deep learning model configured to de-identify the face image. The deep learning model includes multiple neurons that are divided into multiple layers. By converting the face image into feature values of multiple neurons of the first layer among the layers, and inputting the converted feature values of each neuron to the next layer after adding noise generated by using a privacy parameter, the de-identified image data 164 is generated after multiple layers of processing. The I/O interface 128 is configured to output the de-identified image data 164 output by the image signal processor 126.

In some embodiments, the image capture device 12 in FIG. 1 may also adopt the structure of the above-mentioned image capture device 42, but not limited thereto.

In some embodiments, the face image is de-identified by the access control management system and method of the disclosure may include front-end image masking or face swapping, and back-end face image data destruction.

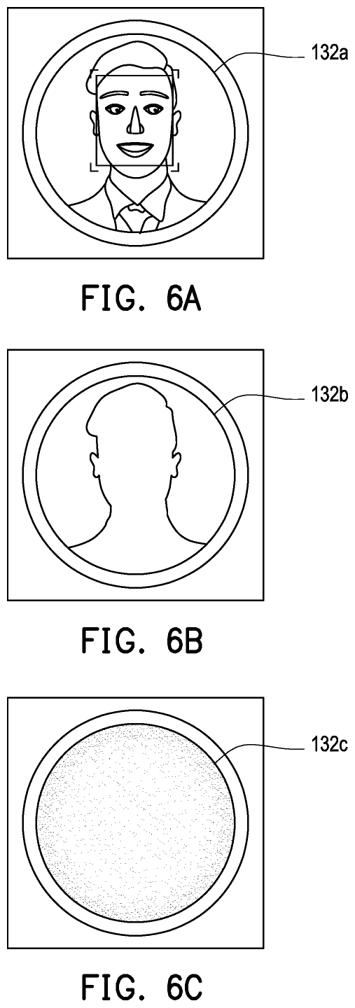

FIG. 6A to FIG. 6C are schematic diagrams of images displayed by the access control management system according to an embodiment of the disclosure. This embodiment illustrates the content of the image 132 displayed on the display 130 by the access control management system 40 in FIG. 4.

As shown in FIG. 6A, the access control management system 40 may display the actual face image 132a of the user on the display 130, thereby letting the user know that their face has been clearly captured by the image capture device 42. It should be noted that after the image capture device 42 captures the face image of the user, the access control management system 40 directly displays the face image on the display 130 without storing the face image, so as to prevent the original data of the face image from being stolen by others.

However, given that the face image displayed on the front end involve the privacy of the user, the user may feel their privacy is being violated when they see their own image on the display 130, even if that image is not stored. In this regard, as shown in FIG. 6B, the access control management system 40 may only display the outline 132b of the user on the display 130, or adopt methods such as image masking or face swapping. This also allows the user to know that their face has been captured by the image capture device 42, thereby securing the privacy of the user.

Alternatively, based on the back-end de-identification and destruction processing of the face image data, as shown in FIG. 6C, the access control system 40 may display the de-identified face image 132c of the user on the display 130, thereby further securing the privacy of the user. Wherein, since the original image is not stored, the de-identified face image 132c is not generated using the stored original image, so the original image may be prevented from being leaked and causing privacy violation.

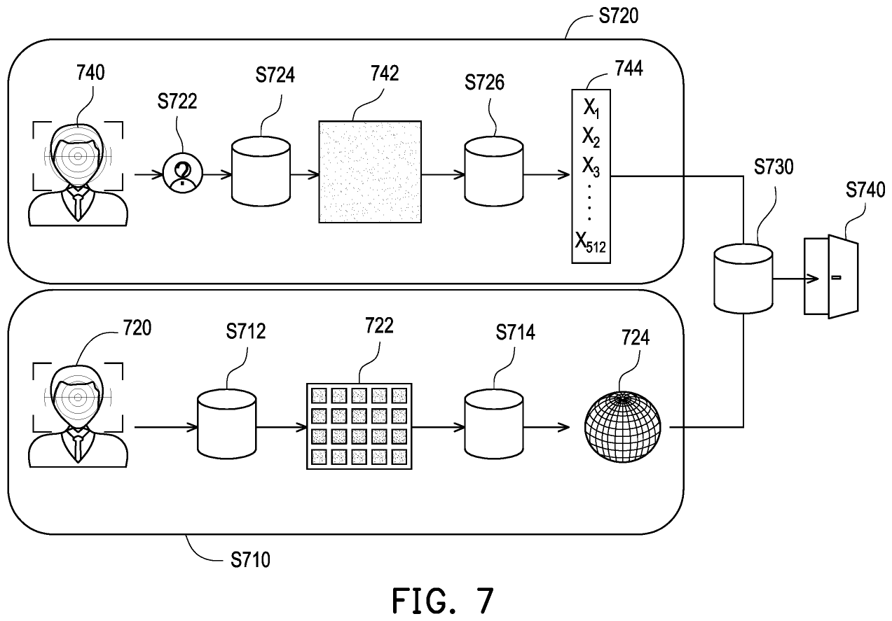

FIG. 7 is a schematic diagram of an access control management method according to an embodiment of the disclosure. Referring to FIG. 4 and FIG. 7 at the same time, the access control management method of this embodiment is applied to the access control management system 40 in FIG. 4, which may also be divided into a registration stage and a recognition stage.

Step S710 is the registration stage, which includes step S712, where the image capture device 42 inputs the captured multiple face images 720 into a deep learning model to generate multiple de-identified image data 722.

In step S714, the image capture device 42 further executes data processing on the de-identified image data, so as to convert the de-identified image data into multiple de-identified features, which are configured to establish a de-identified feature space 724.

Step S720 is the identification stage, which includes step S722, where the image capture device 42 performs living body recognition on the currently captured face image 740 by a living body recognition technology. Therefore, it is possible to prevent others from obtaining the face image in advance and using the face image to deceive the system. The living body recognition technology includes blink detection, deep learning features, challenge-response technology, or a three-dimensional camera, but not limited thereto.

If it is recognized that there is a living body in the current face image 740, then in step S724, the currently captured face image 740 is input into the trained deep learning model by the image capture device 42 to generate de-identified image data 742, and in step S726, the image capture device 42 performs data processing on the de-identified image data 742 to convert the de-identified image data 742 into multiple de-identified features, thereby outputting a de-identified feature vector 744.

Step S730 is also in the recognition phase, the processing device verifies the identity of the user to which the de-identified features belong by a trained deep learning model. The above-mentioned deep learning model is trained by using, for example, de-identified features and identities of multiple users registered in advance. The processing device, for example, calculates a similarity between the de-identified features and a feature space established using the de-identified features of each user registered in advance to verify the identity of the user to which the de-identified features belong according to the calculated similarity.

If the identity of the verified user matches one of the identities of the registered users, then in step S740, the processing device controls the access control management system 40 to open the gate or allow the user to enter the entrance.

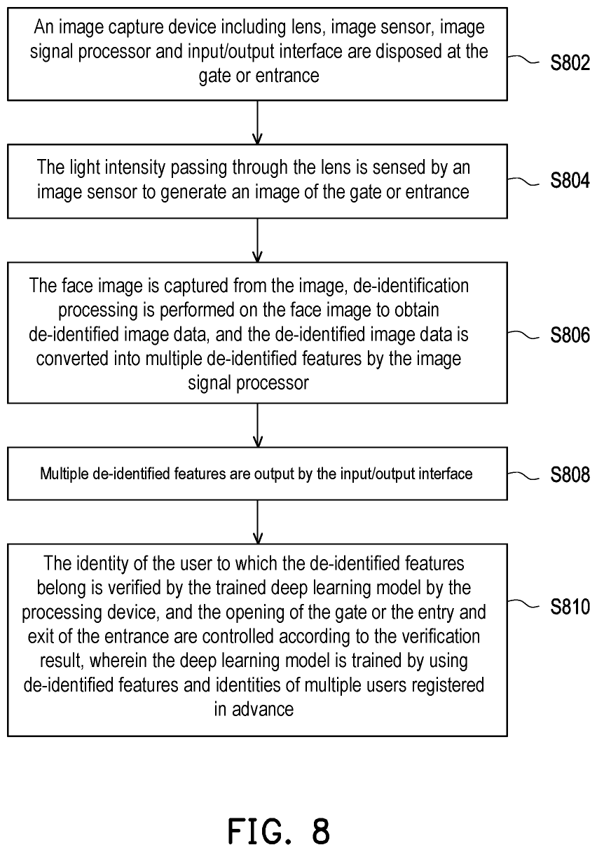

FIG. 8 is a schematic diagram of an access control management method according to an embodiment of the disclosure. Referring to FIG. 4 and FIG. 8 at the same time, the access control management method of this embodiment is applicable to the access control management system 40 in FIG. 4, and is configured to control the opening of the gate or the entry and exit of the entrance.

In step S802, an image capture device 42 including a lens 122, an image sensor 124, and an image signal processor 126 is disposed at the gate or the entrance. The structure of the image capture device 42 and the functions of each component have been described in detail in FIG. 5, so details are not repeated herein.

In step S804, the image sensor 124 is used to sense the light intensity passing through the lens 122 to generate an image of the gate or the entrance.

In step S806, the face image is captured from the image generated by the image sensor 124, the face image is de-identified to obtain de-identified image data, and the de-identified image data is converted into multiple de-identified features by the image signal processor 126. The image signal processor 12, for example, executes a facial recognition algorithm on the image generated by the image sensor 124 to capture a face image, and de-identifies the face image by a deep learning model supporting privacy protection technology. The privacy protection technology includes differential privacy, homomorphic encryption, shuffling or pixelating, but not limited thereto.

In some embodiments, before the image signal processor 126 de-identifies the face image, the access control management system 40, for example, first identifies the living body in the face image by the living body recognition technology by the image capture device 42, and the image signal processor 126 de-identifies the face image only when the living body is identified in the face image. The living body recognition technology includes blink detection, deep learning features, challenge-response technology, or a three-dimensional camera, but not limited thereto.

In step S808, multiple de-identified features are output by the I/O interface. In some embodiments, the access control management system 40 may further use the display 130 to display the de-identified image data generated by the image signal processor 126.

In step S810, the identity of the user to which the de-identified features belong is verified by the trained deep learning model by the processing device, and the opening of the gate or the entry and exit of the entrance are controlled according to the verification result. The deep learning model is trained by using, for example, de-identified features and identities of multiple users registered in advance.

In some embodiments, the processing device, for example, calculates the similarity between the de-identified features and a feature space established using the de-identified features of each user registered in advance by a deep learning model, to verify the identity of the user to which the de-identified features belong according to the calculated similarity.

In some embodiments, the aforementioned facial recognition system or access control management system may be implemented in a single device. For example, a facial recognition system or an access control system may be integrated into an electronic device such as a laptop or a desktop computer, so as to protect the face image of a user from being stolen and at the same time verify the identity of the user.

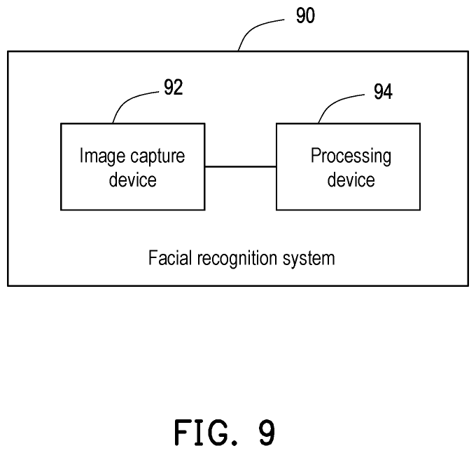

FIG. 9 is a block diagram of a facial recognition system according to an embodiment of the disclosure. Referring to FIG. 9, the facial recognition system 90 of this embodiment includes an image capture device 92 and a processing device 94. The functions of the image capture device 92 and the processing device 94 are the same or similar to the functions of the image capture device 12 and the processing device 14 in the foregoing embodiment, so details are not repeated herein.

Different from the foregoing embodiments, in this embodiment, the facial recognition system 90 may be a system running on a computer. That is, the image capture device 92 and the processing device 94 are integrated into the same device.

The image capture device 92 includes an image signal processor (ISP) supporting a neural network, in which a deep learning model driven by artificial intelligence (AI) is embedded therein, which may de-identify the captured face image to obtain de-identified image data, and convert the de-identified image data into multiple de-identified features.

The processing device 84 is, for example, connected through an interface device such as a universal serial bus (USB) or a system bus, and the processor of the processing device 84 is provided with an application programming interface (API), in which a trained deep learning model is embedded therein. The deep learning model is trained using de-identified features and identities of multiple users registered in advance, and may be configured to verify the identity of the user to which the de-identified features belong. The processing device 84, for example, calculates the similarity between the de-identified features and a feature space established using the de-identified features of each user registered in advance by a deep learning model, to verify the identity of the user to which the de-identified features belong according to the calculated similarity.

To sum up, the access control management system, the access control management method, and the image capture device applied to the access control management system of the disclosure have the following characteristics.

The access control management system, the access control management method, and the image capture device applied to the access control management system have a privacy protection deep neural network (DNN) processing solution for facial recognition, and are easy to integrate with existing multi-factor identity verification systems.

The access control management system is an offload computing system that may perform DNN training and identification tasks in a private manner by designing a privacy protection algorithm for triggering computations.

The access control management system and the access control management method adopts an optimized DNN separation strategy and keeps the first layer from offloading, which is the optimal balance between computational resources, privacy loss, and model quality.

Any image data captured by the access control management system, the access control management method, and the image capture device applied to the access control management system are de-identified and are not visible. At the same time, when the false accept rate (FAR) is 10⁻⁶, the accuracy of the prediction/verification by the access control management system of people entering and leaving may be maintained above 99%.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. An access control management system, configured to control opening of a gate, or entry and exit of an entrance, the access control management system comprising:
an image capture device, disposed at the gate or the entrance, configured to capture a face image of a user to be identified, de-identify the face image to obtain de-identified image data, and convert the de-identified image data into a plurality of de-identified features for subsequent output; and
a processing device, configured to verify an identity of the user to which the de-identified features belong by a trained first deep learning model, and control the opening of the gate or the entry and exit of the entrance according to a verification result, wherein the first deep learning model is trained by using de-identified features and identities of a plurality of users registered in advance.

2. The access control management system according to claim 1, wherein the image capture device comprises:
a lens;
an image sensor, configured to sense light intensity passing through the lens to generate an image of a photographed object;
an image signal processor, configured to capture the face image in the image, de-identify the face image to obtain the de-identified image data, and convert the de-identified image data into the plurality of de-identified features; and
an input/output (I/O) interface, configured to output the de-identified features.

3. The access control management system according to claim 2, wherein the image capture device further comprises:
a display, configured to display the de-identified image data generated by the image signal processor.

4. The access control management system according to claim 1, wherein the processing device further comprises a first communication device configured to communicate with the image capture device or connect to a network; and the image capture device further comprises a second communication device configured to communicate with the first communication device or connect to the network.

5. The access control management system according to claim 1, further comprising:
an interface device, configured to connect the image capture device and the processing device.

6. The access control management system according to claim 1, wherein the first deep learning model is implemented by an application programming interface (API) attached to a processor of the processing device.

7. The access control management system according to claim 1, wherein the image signal processor comprises de-identifying the face image by a second deep learning model supporting privacy protection technology.

8. The access control management system according to claim 7, wherein the second deep learning model comprises a plurality of neurons divided into a plurality of layers, the image signal processor converts the face image into feature values of a plurality of neurons in a first layer among the layers, inputs the converted feature values of each of the neurons to a next layer after adding noise generated by using a privacy parameter, and obtains the de-identified image data after processing the layers.

9. The access control management system according to claim 1, wherein the first deep learning model comprises calculating a similarity between the de-identified features and a feature space established using the de-identified features of each of the users registered in advance, to verify the identity of the user to which the de-identified features belong according to the calculated similarity.

10. The access control management system according to claim 9, wherein the image capture device is further configured to identify a living body in the face image by a living body recognition technology, and de-identify the face image when the living body is identified in the face image, wherein the living body recognition technology comprises blink detection, deep learning features, challenge-response technology, or a three-dimensional camera.

11. An access control management method, configured to control opening of a gate, or entry and exit of an entrance, the method comprising:
disposing an image capture device comprising a lens, an image sensor, an image signal processor, and an input/output (I/O) interface at the gate or the entrance;
sensing light intensity passing through the lens by the image sensor to generate an image of the gate or the entrance;
capturing a face image in the image, de-identifying the face image to obtain de-identified image data, and converting the de-identified image data into a plurality of de-identified features by the image signal processor;
outputting the de-identified features by the I/O interface; and
verifying an identity of a user to which the de-identified features belong by a trained first deep learning model by a processing device, and controlling the opening of the gate or the entry and exit of the entrance according to a verification result, wherein the first deep learning model is trained by using de-identified features and identities of a plurality of users registered in advance.

12. The access control management method according to claim 11, wherein de-identifying the face image to obtain the de-identified image data comprises:
de-identifying the face image by a second deep learning model supporting privacy protection technology by the image capture device.

13. The access control management method according to claim 12, wherein the second deep learning model comprises a plurality of neurons divided into a plurality of layers, and de-identifying the face image to obtain the de-identified image data comprises:
converting the face image into feature values of a plurality of neurons in a first layer among the layers, inputting the converted feature values of each of the neurons to a next layer after adding noise generated by using a privacy parameter, and obtaining the de-identified image data after processing the layers.

14. The access control management method according to claim 11, wherein verifying the identity of the user to which the de-identified features belong by the trained first deep learning model by the processing device comprises:
calculating a similarity between the de-identified features and a feature space established by using the de-identified features of each of the users registered in advance; and
verifying the identity of the user to which the de-identified features belong according to the calculated similarity.

15. The access control management method according to claim 11, further comprising:
identifying a living body in the face image by a living body recognition technology by the image capture device, and de-identifying the face image when the living body is identified in the face image.

16. The access control management method according to claim 11, further comprising:
displaying the de-identified image data generated by the image signal processor by a display of the image capture device.

17. An image capture device, comprising:
a lens;
an image sensor, configured to sense light intensity passing through the lens to generate an image of a photographed object;
an image signal processor, configured to capture a face image in the image, de-identify the face image to obtain de-identified image data, and convert the de-identified image data into a plurality of de-identified features; and
an input/output (I/O) interface, configured to output the de-identified features.

18. The image capture device according to claim 17, wherein the image signal processor comprises de-identifying the face image by a deep learning model supporting privacy protection technology.

19. The image capture device according to claim 17, wherein the image signal processor does not store the face image.

20. The image capture device according to claim 17, wherein the deep learning model comprises a plurality of neurons divided into a plurality of layers, the image signal processor converts the face image into feature values of a plurality of neurons in a first layer among the layers, inputs the converted feature values of each of the neurons to a next layer after adding noise generated by using a privacy parameter, and obtains the de-identified image data after processing the layers.
